(19) United States
(12) Patent Application Publication
(10) Pub. No.: US 2008/0095995 A1
(43) Pub. Date: Apr. 24, 2008

(54) FILTER AND FLAT PANEL DISPLAY DEVICE USING THE FILTER

(76) Inventors: Hong Rae Cha, Seoul (KR); Ji Hoon Sohn, Seoul (KR); Sam Je Cho, Seoul (KR); Woo Sung Jang, Seoul (KR); Woon Seo Shin, Seoul (KR)

Correspondence Address: KED & ASSOCIATES, LLP, P.O. Box 221200, Chantilly, VA, 20153-1200, US

(21) Appl. No.: 11/837,170

(22) Filed: Aug. 10, 2007

(30) Foreign Application Priority Data
Oct. 18, 2006 (KR) 10-2006-0101439
Oct. 18, 2006 (KR) 10-2006-0101440

(51) Int. Cl. B32B 7/02; B32B 17/06; B32B 27/32; B32B 9/04; B32B 27/36; B32B 27/40

(52) U.S. Cl. 428/212; 428/332; 428/411.1; 428/423.1; 428/426; 428/446; 428/480; 428/523

(57) ABSTRACT

A flat panel display device is provided. The flat panel display device includes a display panel and a filter which is disposed at a front of the display panel and includes an external light shield layer. A base unit of the external light shield layer satisfies the following equation: 1.5×h3<h4<2.0×h3 where h3 indicates a drop height of a steel ball having a weigh of 5-9 g to generate a crack in a filter including no impact-resistant layer and h4 indicates a minimum drop height of the steel ball that can result in a crack in a filter including the impact-resistant layer. Therefore, the durability of the filter or the display panel against an external impact can be improved.

This application claims priority from Korean Patent Application No. 10-2006-0101439 filed on Oct. 18, 2006 and Korean Patent Application No 10-2006-0101440 filed on Oct. 18, 2006 in the Korean Intellectual Property Office, the disclosure of which is incorporated herein by reference in its entirety.

### BACKGROUND OF THE INVENTION

1. Field of the Invention

The present invention relates to a filter and a flat panel display device, and more particularly, to a filter which can protect a display panel by absorbing an external impact on the display panel, and a flat panel display device using the filter.

2. Description of the Related Art

Flat panel display devices are display devices such as a liquid crystal display (LCD), a plasma panel display (PDP), an organic light emitting diode (OLED), a field effect diode (FED), and a surface-conduction electron-emitter display (SED) which display images on a flat panel. Flat panel display devices use various driving techniques for displaying images.

In particular, flat panel display devices which can emit light by themselves include upper and lower glass substrates of a display panel and a plurality of electrodes and a plurality of barrier ribs which are disposed between the upper and lower glass substrates and are necessary for emitting light. The electrodes and the barrier ribs are protected by a case.

An upper glass substrate which faces toward a viewer is highly likely to be exposed to external impact. Therefore, an upper glass substrate of a display panel is easy to crack or may result in picture quality deterioration or display panel malfunction. In addition, the properties of light-emitting materials that are disposed on the rear surface of an upper glass substrate may deteriorate even when microcracks are generated in a display panel.

If a display panel is equipped with a filter for improving the optical characteristics of the display panel, the display panel and the filter may both be damaged by external impact. In order to address this, a display panel must include an impact-resistant layer.

### SUMMARY OF THE INVENTION

The present invention provides a filter which can protect a display panel by absorbing an external impact on the display panel, and a flat panel display device using the filter.

According to an aspect of the present invention, there is provided a flat panel display device, including a display panel; and an impact-resistant layer which is disposed at a front of the display panel, includes an elastic material, and protects the display panel against an external impact.

According to another aspect of the present invention, there is provided a flat panel display device, including a display panel; an impact-resistant layer which includes an elastic material and protects the display panel against an external impact; and an external light shield layer which shields external light incident upon the display panel. The external light shield layer includes a base unit and a plurality of pattern units which are formed in the base unit.

According to another aspect of the present invention, there is provided a flat panel display device, including a display panel; and an external light shield layer which shields external light incident upon the display panel. The external light shield layer includes a base unit which includes an elastic material and protects the display panel against an external impact; and a plurality of pattern units which are formed in the base unit.

According to another aspect of the present invention, there is provided a filter which is disposed at a front of a display panel and includes a stack of a plurality of layers, the filter including an impact-resistant layer which includes an elastic material and protects the display panel against an external impact. The impact-resistant layer satisfies the following equation: 1.5×h3<h4<2.0×h3 where h3 indicates a drop height of a steel ball having a weigh of 5-9 g to generate a crack in a filter including no impact-resistant layer and h4 indicates a minimum drop height of the steel ball that can result in a crack in a filter including the impact-resistant layer.

According to another aspect of the present invention, there is provided a filter which is disposed at a front of a display panel and includes a stack of a plurality of layers, the filter including an external light shield layer which shields external light incident upon the display panel. The external light shield layer includes a base unit which includes an elastic material and protects the display panel against an external impact and a plurality of pattern units which are formed in the base unit.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of a display device according to an embodiment of the present invention;

FIG. 2 is a cross-sectional view of an impact-resistant layer according to an embodiment of the present invention;

FIG. 3 is a cross-sectional view of a display device having an impact-resistant layer, according to an embodiment of the present invention;

FIG. 4 is a cross-sectional view of a display device having an impact-resistant layer, according to another embodiment of the present invention;

FIG. 5 is a cross-sectional view of a display device having an impact-resistant layer, according to another embodiment of the present invention;

FIG. 6 is a cross-sectional view of an external light shield layer according to an embodiment of the present invention;

FIGS. 7A through 7F are cross-sectional views of external light shield layers including various shapes of pattern units;

FIG. 8 is a cross-sectional view of an external light shield layer that can absorb an external impact, according to an embodiment of the present invention;

FIG. 9 is a cross-sectional view of a display device having an external light shield layer, according to an embodiment of the present invention; and

FIG. 10 is a cross-sectional view of a display device having an external light shield layer, according to another embodiment of the present invention.

### DETAILED DESCRIPTION OF THE INVENTION

The present invention will hereinafter be described in detail with reference to the accompanying drawings in which exemplary embodiments of the invention are shown.

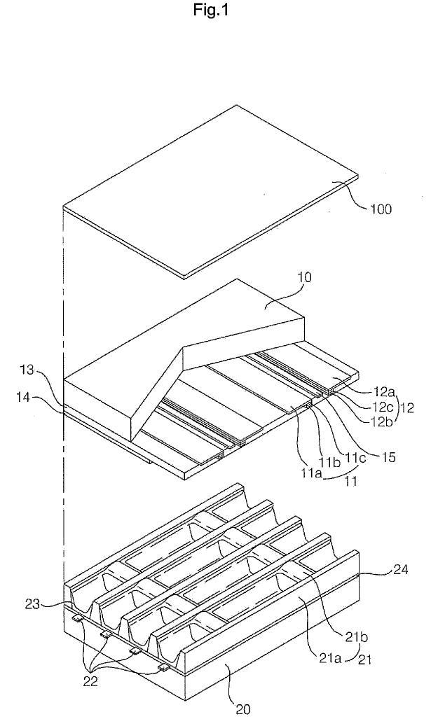

FIG. 1 is a perspective view of a display device according to an embodiment of the present invention. Referring to FIG. 1, a plasma display panel (PDP) includes an upper substrate 10, a plurality of electrode pairs which are formed on the upper substrate 10 and consist of a scan electrode 11 and a sustain electrode 12 each; a lower substrate 20; and a plurality of address electrodes 22 which are formed on the lower substrate 20.

Each of the electrode pairs includes transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may be comprised of a stack of chromium/copper/chromium (Cr/Cu/Cr) or a stack of chromium/aluminiui/chromium (Cr/Al/Cr). The bus electrodes 11b and 12b are respectively formed on the transparent electrodes 11a and 12a and reduce a voltage drop caused by the transparent electrodes 11a and 12a which have a high resistance.

According to an embodiment of the present invention, each of the electrode pairs may be comprised of the bus electrodes 11b and 12b only. In this case, the manufacturing cost of the PDP can be reduced by not using the transparent electrodes 11a and 12a. The bus electrodes 11b and 12b may be formed of various materials other than those set forth herein, e.g., a photosensitive material.

Black matrices are formed on the upper substrate 10. The black matrices perform a light shied function by absorbing external light incident upon the upper substrate 10 so that light reflection can be reduced. In addition, the black matrices enhance the purity and contrast of the upper substrate 10.

In detail, the black matrices include a first black matrix 15 which overlaps a plurality of barrier ribs 21, a second black matrix 11c which is formed between the transparent electrode 11a and the bus electrode 11b of each of the scan electrodes 11, and a second black matrix 12c which is formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may not be physically connected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically separated, the first black matrix 15 and the second black matrices 11c and 12c may be formed of different materials.

An upper dielectric layer 13 and a passivation layer 14 are deposited on the upper substrate 10 on which the scan electrodes 11 and the sustain electrodes 12 are formed in parallel with one other. Charged particles generated as a result of a discharge accumulate in the upper dielectric layer 13. The upper dielectric layer 13 may protect the electrode pairs. The passivation layer 14 protects the upper dielectric layer 13 from sputtering of the charged particles and enhances the discharge of secondary electrons.

The address electrodes 22 are formed and intersects the scan electrode 11 and the sustain electrodes 12. A lower dielectric layer 24 and the barrier ribs 21 are formed on the lower substrate 20 on which the address electrodes 22 are formed.

A phosphor layer 23 is formed on the lower dielectric layer 24 and the barrier ribs 21. The barrier ribs 21 include a plurality of vertical barrier ribs 21a and a plurality of horizontal barrier ribs 21b that form a closed-type barrier rib structure. The barrier ribs 21 define a plurality of discharge cells and prevent ultraviolet (UV) rays and visible rays generated by a discharge from leaking into the discharge cells.

The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

According to an embodiment of the present embodiment, red (R), green (G), and blue (B) discharge cells are arranged in a straight line. However, the present invention is not restricted to this. For example, R, G, and B discharge cells may be arranged as a triangle or a delta. Alternatively, R, G, and B discharge cells may be arranged as a polygon such as a rectangle, a pentagon, or a hexagon.

The phosphor layer 23 is excited by UV rays that are generated upon a gas discharge. As a result, the phosphor layer 23 generates one of R, G, and B rays. A discharge space is provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe is injected into the discharge space.

A filter 100 is disposed at the front of the PDP in order to improve the quality of display of images. The filter 100 may be of a glass type or a film type.

The filter 100 may be comprised of a stack of a plurality of layers, including an external light shield layer. The external light shield layer may be integrated into the filter 100. Alternatively, the external light shield layer may be formed as a separate layer and may be interposed between the filter 100 and the PDP. The external light shield layer may be attached onto the entire surface of the PDP or may be disposed a predetermined distance apart from the PDP.

The external light shield layer can prevent external light incident upon the PDP from being reflected toward a viewer by absorbing external light so that can be prevented from being reflected toward a viewer. Also, the external light shield layer can increase the bright room contrast of an image displayed by the PDP by reflecting image light emitted from the PDP toward outside the PDP.

Referring to FIG. 1, the display device may include an impact-resistant layer which can prevent the PDP or the filter 100 from being damaged by absorbing an external impact on the PDP or the filter 100. The impact-resistant layer may also be integrated into the filter 100. Alternatively, the impact-resistant layer may be formed as a separate layer and may be interposed between the filter 100 and the PDP or may be deposited on the filter 100. An adhesive layer of the external light shield layer included in the filter 100 may be formed as an elastic layer. In this case, the adhesive layer of the external light shield layer can be used as the impact-resistant layer.

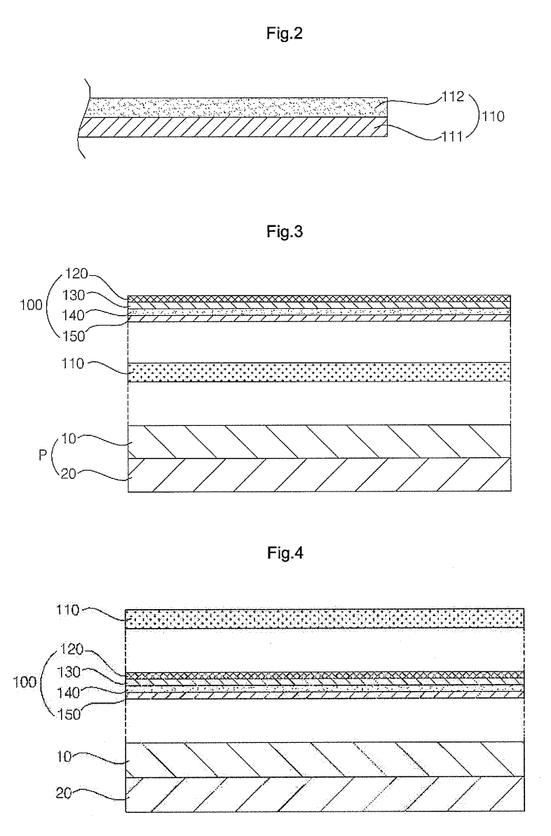

FIG. 2 is a cross-sectional view of an impact-resistant layer 110 according to an embodiment of the present invention. Referring to FIG. 2, the impact-resistant layer includes an elastic material and can thus absorb an external impact on a filter or a PDP.

More specifically, the impact-resistant layer 110 includes a transparent resin layer 111 and a transparent adhesive layer 112. The degree of absorption of an external impact by the impact-resistant layer 110 may be varied by adjusting the elasticity of the transparent adhesive layer 112.

The transparent resin layer 111 may be formed of at least one of polyester resin, polypropylene resin, ethylene acetate vinyl copolymer, polyethylene, and polyurethane. The transparent adhesive layer 112 may be formed of acrylic resin or silicon resin.

The impact-resistant layer 110 may be formed to a thickness of less than 0.3 mm, thereby properly preventing an excessive impact on a PDP. However, if the thickness of the impact-resistant layer 110 exceeds 0.3 mm, a PDP may be disfigured, and the manufacturing cost of a PDP may increase.

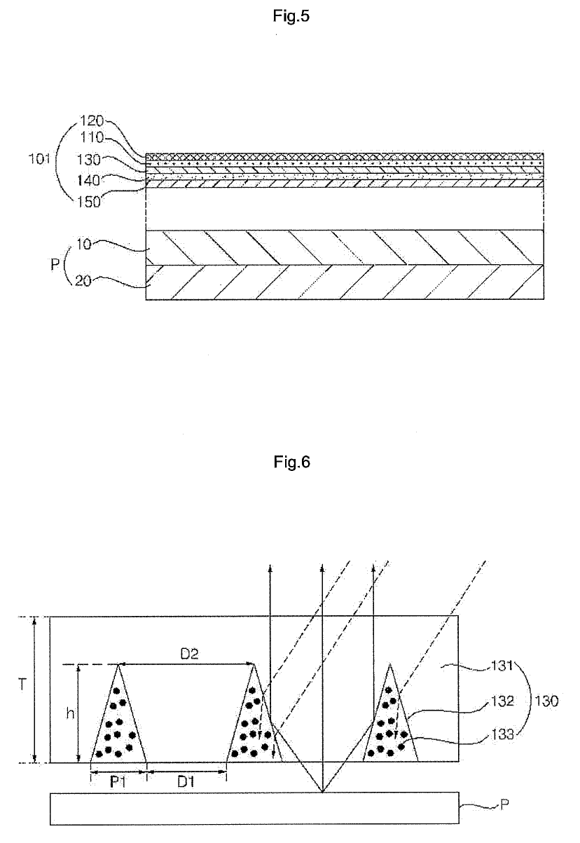

Referring to FIG. 3, the impact-resistant layer 110 may be formed on a PDP P as a separate layer and may be coupled to the PDP P so as to protect the PDP P. Alternatively, referring to FIG. 4, the impact-resistant layer 110 may be formed on the filter 100 as a separate layer so as to protect both a PDP and the filter 100. Still alternatively, referring to FIG. 5, the impact-resistant layer 110 may be integrated into a filter 101 so as to protect both a PDP P and the filter 101.

The impact-resistant layer according to the present invention was subjected to two experiments: experiment 1 for determining a minimum drop height of a steel ball that can result in a crack in a display panel with or without the impact-resistant layer according to the present invention and experiment 2 for determining a minimum drop height of a steel ball that can result in a crack in a filter with or without the impact-resistant layer according to the present invention. The crack in a filter may be a crack in at least one layer of a pluraity of layers included in the filter, for example, a glass included in the filter.

Steel balls having a weight of 5-9 g, particularly, a weight of 7-8.5 g, were used in experiments 1 and 2 in consideration of the amounts of impact energy that are highly likely to be generated from various events in our daily lives.

The amount of impact energy is determined by the weight of a steel ball and the height from which the steel ball is dropped. In other words, the potential energy of a steel ball is converted into impact energy on a display panel, and a crack is generated in the display panel due to the impact energy.

The crack in the display panel is not a microcrack that is invisible without an optical aid such as a microscope, but a crack that is visible to the naked eye of a viewer.

Results of experiment 1 are as follows.

When a steel ball having a weight of 7 g was dropped onto a bare display panel with no impact-resistant layer from a height of 50 cm, a crack began to be generated in the bare display panel. On the other hand, when a steel ball having the weight of 7 g was dropped onto the display panel with an impact-resistant layer deposited thereon from a height of 160 cm, a crack began to be generated in the display panel.

When a steel ball having a weight of 8.3 g was dropped onto a bare display panel with no impact-resistant layer from a height of 42 cm, a crack began to be generated in the bare display panel. On the other hand, when a steel ball having the weight of 8.3 g was dropped onto a display panel with an impact-resistant layer deposited thereon from a height of 145 cm, a crack began to be generated in the display panel.

When 1.5×h1<h2<10×h1 where h1 indicates a minimum drop height of a steel ball that can result in a crack in a bare display panel with no impact-resistant layer and h2 indicates a minimum drop height of the steel ball that can result in a crack in a display panel with an impact-resistant layer, it is possible to facilitate the manufacture of the impact-resistant layer, optimize the transmissivity of the impact-resistant layer and the brightness of a PDP, and absorb an external impact on a PDP efficiently.

More specifically, the following equation may be established based on the results of experiment 1 and a manufacturing efficiency of the impact-resistant layer and in consideration of errors in experiment 1: 2.5×h1<h2<3.5×h1.

Therefore, the impact-resistant layer according to the present invention may be formed to satisfy the following equations: 1.5×h1<h2<10×h1 or 2.5×h1<h2<3.5×h1. Then, the impact-resistant layer according to the present invention may be applied to a filter and/or a display panel.

Experiment 2 will hereinafter be described in detail.

The impact-resistant layer according to the present invention may be formed as a separate layer and may be deposited on a filter, which is disposed at a front of a display panel, as illustrated in FIG. 4. Alternatively, the impact-resistant layer according to the present invention may be inserted into a filter, as illustrated in FIG. 5.

Results of experiment 2 are as follows.

When a steel ball having a weight of 7 g was dropped onto a bare filter with no impact-resistant layer from a height of 90 cm, a crack began to be generated in the bare filter. On the other hand, when a steel ball having the weight of 7 g was dropped onto a filter with an impact-resistant layer from a height of 140 cm, a crack began to be generated in the filter.

When the height from which a steel ball having a weight of 8.3 g is dropped onto a bare filter with no impact-resistant layer is 75 cm, a crack began to be generated in the bare filter. On the other hand, when a steel ball having the weight of 8.3 g was dropped onto a filter with an impact-resistant layer from a height of 125 cm, a crack began to be generated in the filter.

When 1.5×h3<h4<10×h3 where h3 indicates a minimum drop height of a steel ball that can result in a crack in a bare filter with no impact-resistant layer and h4 indicates the minimum drop height of the steel ball that can result in a crack in a filter with an impact-resistant layer, it is possible to facilitate the manufacture of the impact-resistant layer, optimize the transmissivity of the impact-resistant layer and the brightness of a PDP, and absorb an external impact on a filter efficiently.

More specifically, the following equation may be established based on the results of experiment 2 and a manufacturing efficiency of the impact-resistant layer and in consideration of errors in experiment 2: 1.5×h3<h4<2.0×h3.

Therefore, the impact-resistant layer according to the present invention may be formed to satisfy the following equations: 1.5×h3<h4<10×h3 or 1.5×h3<h4<2.0×h3. Then, the impact-resistant layer according to the present invention may be applied to a filter and/or a display panel.

FIGS. 3 through 5 are cross-sectional views of display devices according to embodiments of the present invention. Referring to FIG. 3, the impact-resistant layer 110 is interposed between the filter 100 and the PDP P so as to protect the PDP P. Referring to FIG. 4, the impact-resistant layer 110 is deposited on the filter 100 so as to protect the PDP P and the filter 100. Referring to FIG. 5, the impact-resistant layer 110 is formed in the filter 101 so as to protect the PDP P and the filter 101.

Referring to FIGS. 3 through 5, the filter 100 or 101 may include at least one of an anti-reflection (AR) layer 120, a near infrared (NIR) shield layer 140, an electromagnetic interference (EMI) shield layer 150, a color correction layer, an external light shield layer 130, and a transparent support layer.

At least one layer may be deposited on the PDP P or may be included in the filter 100 or 101. Examples of the layer that may be deposited on the PDP P or may be included in the filter 101 or 101 include an anti-glare layer which reduces the reflection of external light, a matt coating layer, an anti-static layer and a coating layer which can prevent static electricity and contamination that originates from an external environment, a color correction layer and a Ne light shield coating layer which can improve color purity, and a diffusion layer which can widen vertical and horizontal viewing angles of a display screen by uniformly diffusing light emitted from the PDP P. However, the present invention is not restricted to those set forth herein.

The AR layer 120 prevents the reflection of external light and can thus reduce glare. The AR layer 120 may be formed as an outermost layer of a plurality of layers that are attached onto the PDP P or constitute the filter 100 or 101.

The NIR shield layer 140 shields NIR rays emitted from the PDP P and can thus enable IR signals, which are signals that are transmitted via, for example, a remote control using IR rays, to be smoothly transmitted. The EMI shield layer 150 shields EMI emitted from the PDP P.

The EMI shield layer 150 may be formed of a conductive material as a mesh. In order to properly ground the EMI shield layer 150, an invalid display area on the PDP P where no images are displayed may be covered with a conductive material.

The NIR shield layer 140 and the EMI shield layer 150 may be disposed in the vicinity of the PDP P.

An external light source is generally located over the head of a user regardless of an indoor or outdoor environment. In order to effectively shield such external light and to render black images even blacker, the external light shielding sheet 130 may be included in the filter 100 or 101.

The order in which the AR layer 120, the NIR shield layer 140, the EMI shield layer 150, and the external light shield layer 130 are disposed is not restricted to that set forth herein. At least one of the AR layer 120, the NIR shield layer 140, the EMI shield layer 150, and the external light shield layer 130 is optional. In addition, a number of layers, other than the AR layer 120, the NIR shield layer 140, the EMI shield layer 150, and the external light shield layer 130, may be additionally deposited on the PDP P.

FIG. 6 is a cross-sectional view of the external light shield layer 130. Referring to FIG. 6, the external light shield layer 130 includes a base unit 131 which is transparent, and one or more pattern units 132 which are formed in the base unit 131 as grooves. Dark particles 133 may be included in each of the pattern units 131.

The base unit 131 may be formed of a transparent plastic material, e.g., a UV-hardened resin-based material, so that light can smoothly transmit therethrough. Alternatively, the base unit 131 may be formed of a rigid material such as glass in order to enhance the protection of an entire surface of a PDP.

Each of the pattern units 132 may be formed by forming a groove in the base unit 131 and inserting the dark particles 133 into the groove. The pattern units 132 may be triangular, rectangular, or trapezoidal. The pattern units 132 may be symmetrical or asymmetrical with respect to their respective horizontal axes.

The dark particles 133 may be darker than the material of the base unit 131 and may be formed of a black material. For example, the pattern units 132 may be formed of a carbon-based material or may be dyed black so that the absorption of external light can be maximized.

The size and weight of the dark particles 133 may be determined so that the manufacture of the dark particles 133 and the insertion of the dark particles 133 into the pattern units 132 can be facilitated, and that the absorption of external light by the external light shield layer 130 can be maximized. More specifically, if the dark particles 133 have a size of 1 μm or more, each of the pattern units 132 may contain 10 weight % or more of dark particles 133. If the dark particles 133 have a size of less than 1 μm, each of the pattern units 132 may contain 2-10 weight % of dark particles 133.

The dark particles 133 are illustrated in FIG. 6 as being circular, but the present invention is not restricted to this. In other words, the dark particles 133 may be formed in various shapes, other than a circular shape, as long as the diameter of an inscribed circle of each of the dark particles 133 is 1 μm or more.

The dark particles 133 may have different sizes. In this case, the average of the sizes of the dark particles 133 may be 1 μm or more.

The refractive index of the pattern units 132 may be 0.3-1 times higher than the refractive index of the base unit 131. In this case, it is possible to maximize the absorption of external light and the total reflection of light emitted from a PDP in consideration of the angle of external light incident upon the PDP. In particular, the refractive index of the pattern units 132 may be set to be 0.3-0.8 times higher than the refractive index of the base unit 131 in consideration of a vertical viewing angle of the PDP. In this case, it is possible to maximize the total reflection of light emitted from a PDP by the slanted surfaces of the pattern units 132.

In other words, external light that is diagonally incident upon the external light shield layer 130 is refracted into and absorbed by the pattern units 132 which have a lower refractive index than the base unit 131, and light emitted from a PDP toward outside the PDP is totally reflected from the slanted surfaces of the pattern units 132 and is thus emitted toward outside the PDP, i.e., toward a user.

Therefore, the external light shield layer 130 can improve the bright room contrast of images displayed by a PDP by increasing the reflection of light emitted from the PDP and absorbing external light incident upon the PDP so that external light can be prevented from being reflected toward a user.

When the refractive index of the pattern units 132 is lower than the refractive index of the base unit 131, light emitted from the panel P is reflected by the surfaces of the pattern units 132 and thus spreads out toward the user, thereby resulting in unclear, blurry images, i.e., a ghost phenomenon.

When the refractive index of the pattern units 132 is higher than the refractive index of the base unit 131, external light incident upon the pattern units 132 and light emitted from the panel P are both absorbed by the pattern units 132. Therefore, it is possible to reduce the probability of occurrence of the ghost phenomenon.

In order to absorb as much panel light as possible and thus to prevent the ghost phenomenon, the refractive index of the pattern units 132 may be 0.05 or more higher than the refractive index of the base unit 131.

When the refractive index of the pattern units 132 is higher than the refractive index of the base unit 131, the transmissivity and contrast of an external light shield sheet may decrease. In order not to considerably reduce the transmissivity and contrast of an external light shield sheet while preventing the ghost phenomenon, the refractive index of the pattern units 132 may be 0.05-0.3 higher than the refractive index of the base unit 131. Also, in order to uniformly maintain the contrast of the panel P while preventing the ghost phenomenon, the refractive index of the pattern units 132 may be 1.0-1.3 times greater than the refractive index of the base unit 131.

A thickness T of the external light shield layer 130 may be 20-250 μm. In this case, it is possible to facilitate the manufacture of the external light shield layer 130 and optimize the transmissivity of the external light shied layer 130. More specifically, the thickness T may be 100-180 μm. In this case, it is possible to effectively absorb and shield external light refracted into the pattern units 132 and to enhance the durability of the external light shield layer 130.

A height h of the pattern units 132 in the base unit 131 may be 80-170 μm. In this case, it is possible to effectively shield external light and prevent the pattern units 132 from being short-circuited.

A bottom width P1 of the pattern units 132 may be 18-35 μm. The slopes of the slanted surfaces of the pattern units 132 may be determined in consideration of the bottom width P1 and the height h so that the absorption of external light by the external light shield layer 130 can be increased, and that a sufficient aperture ratio to properly emit light generated by a PDP can be secured.

A distance D1 between the bottoms of a pair of adjacent pattern units 132 may be 40-90 μm, and a distance D2 between the tops of the pair of adjacent pattern units 132 may be 60-130 μm. In this case, it is possible to achieve a sufficient aperture ratio to display images with optimum luminance through the emission of light generated by a PDP toward a user and provide a plurality of pattern units 132 having slanted surfaces with an optimum slope for enhancing the absorption of external light and the emission of panel image light generated by a PDP. In particular, the distance D1 may be 2.5-5 times greater than the bottom width P1. In this case, it is possible to secure an optimum aperture ratio and enhance the absorption of external light and the emission of panel light.

The height h may be 1.1-2 times greater than the distance D1. In this case, it is possible to prevent external light from being incident upon a PDP and to optimize the reflection of panel light generated by the PDP.

The distance D2 may be 1.1-1.45 times greater than the distance D1. In this case, it is possible to secure a sufficient aperture ratio to display images with an optimum luminance and to enhance the total reflection of panel light by the slanted surfaces of the pattern units 132.

The height h can be varied according to the thickness T. More specifically, the height h may be within a predetermined percentage range of the thickness T. As the height h increases, the thickness of the base unit 131 decreases, and thus, dielectric breakdown is more likely to occur. On the other hand, as the height h decreases, more external light is likely to be incident upon a PDP at various angles within a predetermined range, and thus it becomes more difficult for the external light shield layer 130 to properly shield such external light.

Table 1 presents experimental results obtained by testing a plurality of external light shielding sheets having the same thickness T and different pattern unit heights h for whether they cause dielectric breakdown and whether they can shield external light.

TABLE 1

| Thickness (T) of | | | |
|---|---|---|---|
| External Light | Height (h) of | Dielectric | External Light |
| Shield Layer | Pattern Units | Breakdown | Shield |
| 120 μm | 120 μm | ◯ | ◯ |
| 120 μm | 115 μm | Δ | ◯ |
| 120 μm | 110 μm | X | ◯ |
| 120 μm | 105 μm | X | ◯ |
| 120 μm | 100 μm | X | ◯ |
| 120 μm | 95 μm | X | ◯ |
| 120 μm | 90 μm | X | ◯ |
| 120 μm | 85 μm | X | Δ |
| 120 μm | 80 μm | X | Δ |
| 120 μm | 75 μm | X | X |

Referring to Table 1, when the thickness T is 120 μm and the height h is greater than 115 μm, the pattern units 132 are highly likely to dielectrically break down, thereby increasing defect rates. When the height h is less than 115 μm, the pattern units 132 are less likely to dielectrically break down, thereby reducing defect rates. When the height h is less than 85 μm, the external light shielding efficiency of the pattern units 132 is likely to decrease. When the height h is less than 75 μm, external light is likely to be directly incident upon a PDP.

When the thickness T is 1.01-2.25 times greater than the height h, it is possible to prevent the upper portions of the pattern units 132 from dielectrically breaking down and to prevent external light from being incident upon a PDP. The thickness T may be 1.01-1.35 times greater than the height h. In this case, it is possible to prevent dielectric breakdown of the pattern units 132 and infiltration of external light into a PDP, to increase the reflection of light emitted from a PDP, and to secure optimum viewing angles.

Table 2 presents experimental results obtained by testing a plurality of external light shielding sheets having different pattern unit bottom width (P1)-to-bus electrode width ratios for whether they cause the moire phenomenon and whether they can shield external light, when the width of bus electrodes that are formed on an upper substrate of a PDP is 90 μm.

TABLE 2

| Bottom Width of Pattern | | External Light |
|---|---|---|
| Units/Width of Bus Electrodes | Moire | Shield |
| 0.10 | Δ | X |
| 0.15 | Δ | X |
| 0.20 | X | Δ |
| 0.25 | X | ◯ |
| 0.30 | X | ◯ |
| 0.35 | X | ◯ |
| 0.40 | X | ◯ |
| 0.45 | Δ | ◯ |
| 0.50 | Δ | ◯ |
| 0.55 | ◯ | ◯ |
| 0.60 | ◯ | ◯ |

Referring to Table 2, when the bottom width P1 is 0.2-0.5 times greater than the bus electrode width, the moire phenomenon can be prevented and the amount of external light incident upon a PDP can be reduced. The bottom width P1 may be 0.25-0.4 times greater than the bus electrode width. In this case, it is possible to prevent the moire phenomenon, to effectively shield external light, and to secure a sufficient opening ratio to discharge light emitted from a PDP.

Table 3 presents experimental results obtained by testing a plurality of external light shielding sheets having different pattern unit bottom width (P1)-to-vertical barrier rib width ratios for whether they cause the moire phenomenon and whether they can shield external light, when the width of vertical barrier ribs that are formed on a lower substrate of a PDP is 50 μm.

TABLE 3

| Bottom Width of Pattern | | |
|---|---|---|
| Units/Top Width of Vertical | | External Light |
| Barrier Ribs | Moire | Shield |
| 0.10 | ◯ | X |
| 0.15 | Δ | X |
| 0.20 | Δ | X |
| 0.25 | Δ | X |
| 0.30 | X | Δ |
| 0.35 | X | Δ |
| 0.40 | X | ◯ |
| 0.45 | X | ◯ |
| 0.50 | X | ◯ |
| 0.55 | X | ◯ |
| 0.60 | X | ◯ |
| 0.65 | X | ◯ |
| 0.70 | Δ | ◯ |
| 0.75 | Δ | ◯ |
| 0.80 | Δ | ◯ |
| 0.85 | ◯ | ◯ |
| 0.90 | ◯ | ◯ |

Referring to Table 3, when the bottom width P1 is 0.3-0.8 times greater than the vertical barrier rib width, the moire phenomenon can be prevented and the amount of external light incident upon a PDP can be reduced. The bottom width P1 may be 0.4-0.65 times greater than the vertical barrier rib width. In this case, it is possible to prevent the moire phenomenon, to effectively shield external light, and to secure a sufficient opening ratio to discharge light emitted from a PDP.

FIG. 6 illustrates the situation when the bottoms of pattern units 132 faces toward a panel P. But the bottoms of pattern units 132 may face toward a user, and the tops of pattern units 132 may face toward a panel P. In this case, external light is absorbed by the bottoms of the pattern units 132, thereby enhancing the shielding of external light. The distance between a pair of adjacent pattern units 132 may be widened compared to the distance between a pair of adjacent pattern units 132. Therefore, it is possible to enhance the aperture ratio of an external light shield sheet.

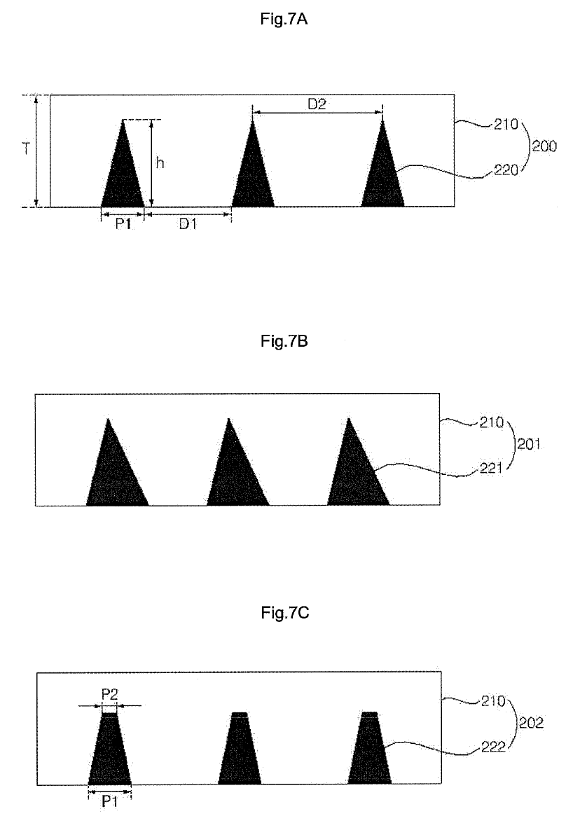

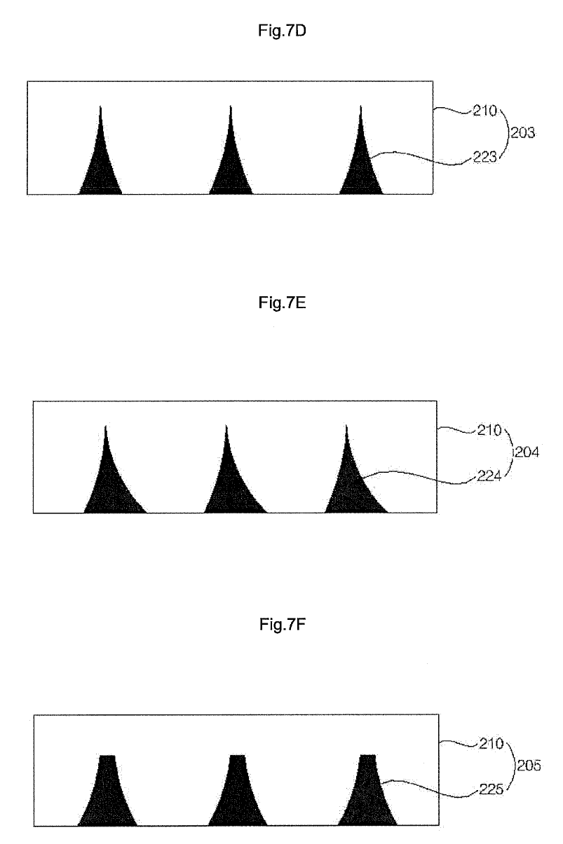

FIGS. 7A through 7F are cross-sectional views of external light shield layers 200 through 205 having various shapes of pattern units 220 through 225, respectively, according to embodiments of the present invention.

Referring to FIG. 7A, the pattern units 220 may be formed as equilateral triangles, and may be disposed so that the bases of the equilateral triangles can face toward a PDP.

Referring to FIG. 7B, the pattern units 221 may be asymmetrical with respect to their respective horizontal axes. In other words, a pair of slanted surfaces of each of the pattern units 221 may have different areas or may form different angles with the bottom of an external light shield layer 201.

In general, an external light source is located above a PDP. Thus, external light is highly likely to be incident upon a PDP from above at various angles within a predetermined range. One of a pair of slanted surfaces of each of the pattern units 221 upon which external light is directly incident will hereinafter be referred to as an upper slanted surface, and the other slanted surface will hereinafter be referred to as a lower slanted surface. The upper slanted surfaces of the pattern units 221 may be less steep than the lower slanted surfaces of the pattern units 221. In this case, it is possible to enhance the absorption of external light and the reflection of light emitted from a PDP. That is, the slope of the upper slanted surfaces of the pattern units 221 may be less than the slope of the lower slanted surfaces of the pattern units 221.

Referring to FIG. 7C, the pattern units 222 may be trapezoidal. In this case, a top width P2 of the pattern units 222 is less than a bottom width P1 of the pattern units 222. The top width P2 may be 5 μm or less. The slopes of the slanted surfaces of the pattern units 222 may be appropriately determined in consideration of the relationship between the bottom width P1 and the top width P2 so that the absorption of external light and the reflection of light emitted from a PDP can be maximized.

The pattern units 203, 204, and 205 illustrated in FIGS. 7D, 7E, and 7F have the same shapes as the pattern units 200, 201, and 202, respectively, illustrated in FIGS. 7A, 7B, and 7C except that the pattern units 203, 204, and 205 have curved lateral surfaces. According to an embodiment of the present invention, each of a plurality of pattern units may have a curved top or bottom surface.

Referring to FIGS. 7A through 7F, each of the pattern units 220 through 225 may have curved edges having a predetermined curvature. More specifically, the pattern units 220 through 225 may have outwardly extending, curved lower edges.

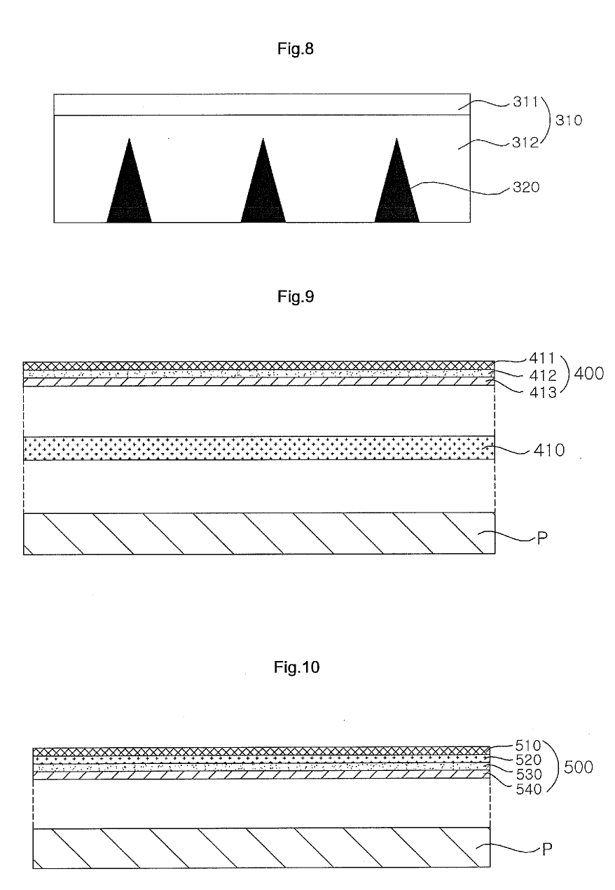

FIG. 8 is a cross-sectional view of an external light shield layer which can absorb an external impact, according to an embodiment of the present invention. Referring to FIG. 8, a base unit 310 may be comprised of a transparent resin layer 312 and a transparent adhesive layer 311. The degree of absorption of an external impact by the external light shield layer may be varied by adjusting the elasticity and Young's modulus of the transparent adhesive layer 311.

The transparent resin layer 311 may be formed of at least one of polyester resin, polypropylene resin, ethylene acetate vinyl copolymer, polyethylene, and polyurethane. The transparent adhesive layer 312 may be formed of acrylic resin or silicon resin.

The base unit 310 may be formed to a thickness of less than 0.3 mm, thereby properly preventing an excessive impact on a PDP. However, if the thickness of the base unit 310 exceeds 0.3 mm, a PDP may be disfigured, and the manufacturing cost of a PDP may increase.

The external light shield layer according to the present invention was subjected to two experiments: experiment 3 for determining a minimum drop height of a steel ball that can result in a crack in a display panel with or without the external light shield layer according to the present invention and experiment 4 for determining a minimum drop height of a steel ball that can result in a crack in a filter with or without the external light shield layer according to the present invention. The crack in a filter may be a crack in at least one layer of a pluraity of layers included in the filter, for example, a glass included in the filter.

Steel balls having a weight of 5-9 g, particularly, a weight of 7-8.5 g, were used in experiments 1 and 2 in consideration of the amounts of impact energy that are highly likely to be generated from various events in our daily lives.

The amount of impact energy is determined by the weight of a steel ball and the height from which the steel ball is dropped. In other words, the potential energy of a steel ball is converted into impact energy on a display panel, and a crack is generated in the display panel due to the impact energy.

The crack in the display panel is not a microcrack that is invisible without an optical aid such as a microscope, but a crack that is visible to the naked eye of a viewer.

Results of experiment 3 are as follows.

When a steel ball having a weight of 7 g was dropped onto a bare display panel with no external light shield layer from a height of 50 cm, a crack began to be generated in the bare display panel. On the other hand, when a steel ball having the weight of 7 g was dropped onto the display panel with an external light shield layer deposited thereon from a height of 160 cm, a crack began to be generated in the display panel.

When a steel ball having a weight of 8.3 g was dropped onto a bare display panel with no external light shield layer from a height of 42 cm, a crack began to be generated in the bare display panel. On the other hand, when a steel ball having the weight of 8.3 g was dropped onto a display panel with an external light shield layer deposited thereon from a height of 145 cm, a crack began to be generated in the display panel.

When 1.5×h5<h6<10×h5 where h5 indicates a minimum drop height of a steel ball that can result in a crack in a bare display panel with no external light shield layer and h6 indicates a minimum drop height of the steel ball that can result in a crack in a display panel with an external light shield layer deposited thereon, it is possible to facilitate the manufacture of the external light shield, optimize the transmissivity of the external light shield layer and the brightness of a PDP, and absorb an external impact on a PDP efficiently.

More specifically, the following equation may be established based on the results of experiment 1 and a manufacturing efficiency of the external light shield layer and in consideration of errors in experiment 3: 2.5×h5<h6<3.5×h5.

Therefore, the external light shield layer according to the present invention may be formed to satisfy the following equations: 1.5×h5<h6<10×h5 or 2.5×h5<h6<3.5×h5. Then, the external light shield layer according to the present invention may be applied to a filter and/or a display panel.

Results of experiment 4 are as follows.

When a steel ball having a weight of 7 g was dropped onto a bare filter with no external light shield layer from a height of 90 cm, a crack began to be generated in the bare filter. On the other hand, when a steel ball having the weight of 7 g was dropped onto a filter with an external light shield layer from a height of 140 cm, a crack began to be generated in the filter.

When the height from which a steel ball having a weight of 8.3 g is dropped onto a bare filter with no external light shield layer is 75 cm, a crack began to be generated in the bare filter. On the other hand, when a steel ball having the weight of 8.3 g was dropped onto a filter with an external light shield layer from a height of 125 cm, a crack began to be generated in the filter.

When 1.5×h7<h8<10×h7 where h7 indicates a minimum drop height of a steel ball that can result in a crack in a bare filter with no external light shield layer and h8 indicates the minimum drop height of the steel ball that can result in a crack in a filter with an external light shield layer, it is possible to facilitate the manufacture of the external light shield layer, optimize the transmissivity of the external light shield layer and the brightness of a PDP, and absorb an external impact on a filter efficiently.

More specifically, the following equation may be established based on the results of experiment 2 and a manufacturing efficiency of the external light shield layer and in consideration of errors in experiment 4: 1.5×h7<h8<2.0×h7.

Therefore, the external light shield layer according to the present invention may be formed to satisfy the following equations: 1.5×h7<h8<10×h7 or 1.5×h7<h8<2.0×h7. Then, the external light shield layer according to the present invention may be applied to a filter and/or a display panel.

The embodiments of FIGS. 7A through 7F can be applied to the pattern units 320 illustrated in FIG. 8.

FIGS. 9 and 10 are cross-sectional views of display devices according to embodiments of the present invention. Referring to FIG. 9, an external light shield layer 410 is interposed between a filter 400 and a PDP P so as to protect the PDP P. Referring to FIG. 10, an external light shield layer 520 is formed as an element of a filter 500 so as to protect the filter 500 and a PDP P.

Referring to FIGS. 9 and 10, the filter 400 or 500 may include at least one of an AR layer 411 or 510, an NIR shield layer 412 or 530, and an EMI shield layer 413 or 540.

At least one layer may be deposited on the PDP P or may be included in the filter 400 or 500. Examples of the layer that may be deposited on the PDP P or may be included in the filter 400 or 500 include an anti-glare layer which reduces the reflection of external light, a matt coating layer, an anti-static layer and a coating layer which can prevent static electricity and contamination that originates from an external environment, a color correction layer and a Ne light shield coating layer which can improve color purity, and a diffusion layer which can widen vertical and horizontal viewing angles of a display screen by uniformly diffusing light emitted from a PDP. However, the present invention is not restricted to those set forth herein.

The AR layer 411 or 510 prevents the reflection of external light and can thus reduce glare. The AR layer 411 or 510 may be formed as an outermost layer of a plurality of layers that are attached onto the PDP P or constitute the filter 400 or 500.

The NIR shield layer 412 or 530 shields NIR rays emitted from the PDP P and can thus enable IR signals, which are signals that are transmitted via, for example, a remote control using IR rays, to be smoothly transmitted. The EMI shield layer 413 or 540 shields EMI emitted from the PDP P.

The EMI shield layer 413 or 540 may be formed of a conductive material as a mesh. In order to properly ground the EMI shield layer 413 or 540, an invalid display area on the PDP P where no images are displayed may be covered with a conductive material.

The NIR shield layer 412 or 530 and the EMI shield layer 413 or 540 may be disposed in the vicinity of the PDP P.

An external light source is generally located over the head of a user regardless of an indoor or outdoor environment. In order to effectively shield such external light and to render black images even blacker, the external light shielding sheet 410 or 510 may be included in the filter 400 or 500.

The order in which the AR layer 120, the NIR shield layer 140, the EMI shield layer 150, and the external light shield layer 130 are disposed is not restricted to that set forth herein. At least one of the AR layer 120, the NIR shield layer 140, the EMI shield layer 150, and the external light shield layer 130 is optional. In addition, a number of layers, other than the AR layer 120, the NIR shield layer 140, the EMI shield layer 150, and the external light shield layer 130, may be additionally deposited on the PDP P.

Referring to FIG. 10, the NIR shield layer 530 and the EMI shield layer 540 may be disposed in the vicinity of the PDP P. Thus, the external light shield layer 510 may be included in the filter 500 and may be interposed between the AR layer 510 and the PDP P, and particularly, between the AR layer 510 and the NIR shield layer 530.

The order in which the AR layer 411 or 510, the NIR shield layer 412 or 530, the EMI shield layer 413 or 540, and the external light shield layer 410 or 520 are disposed is not restricted to that set forth herein. At least one of the AR layer 411 or 510, the NIR shield layer 412 or 530, the EMI shield layer 413 or 540, and the external light shield layer 410 or 520 is optional. In addition, a number of layers, other than the AR layer 411 or 510, the NIR shield layer 412 or 530, the EMI shield layer 413 or 540, and the external light shield layer 410 or 520, may be additionally deposited on the PDP P.

The impact-resistant layer according to the present invention may be deposited on a PDP, thereby protecting the PDP against an external impact and improving the durability of the PDP. The impact-resistant layer according to the present invention may be included in a filter, thereby improving the durability of the filter.

The display device according to the present invention includes an external light shield layer which can absorb an external impact. Thus, the display device according to the present invention can effectively realize black images, and improve bright room contrast. In addition, since the Young's modulus of a base unit of the external light shield layer is sufficiently high to absorb an external impact, it is possible to improve the durability of a display device by effectively protecting a filter and a PDP with the aid of the external light shield layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A flat panel display device, comprising:
a display panel; and
an impact-resistant layer which is disposed at a front of the display panel, includes an elastic material, and protects the display panel against an external impact, wherein the impact-resistant layer satisfies the following equation: 1.5×h1<h2<10×h1 where h1 indicates a drop height of a steel ball having a weigh of 5-9 g to generate a crack in a display panel with no impact-resistant layer deposited thereon and h2 indicates a minimum drop height of the steel ball that can result in a crack in a display panel with the impact-resistant layer deposited thereon.

2. The flat panel display device of claim 1, wherein the impact-resistant layer satisfies the following equation: 2.5×h1<h2<3.5×h1.

3. The flat panel display device of claim 1, wherein a thickness of the impact-resistant layer is 0.3 mm or less.

4. The flat panel display device of claim 1, wherein the impact-resistant layer comprises at least one of a transparent resin layer and a transparent adhesive layer.

5. The flat panel display device of claim 4, wherein the transparent resin layer is formed of at least one of polyester resin, polypropylene resin, ethylene acetate vinyl copolymer, polyethylene, and polyurethane.

6. The flat panel display device of claim 4, wherein the transparent adhesive layer is formed of at least one of acrylic resin and silicon resin.

7. The flat panel display device of claim 1, further comprising a filter which comprises a stack of a plurality of layers including the impact-resistant layer,
wherein the filter is a film-type filter that is formed on a transparent film element.

8. A flat panel display device, comprising:
a display panel; and
a filter which comprises a stack of a plurality of layers including a impact-resistant layer,
wherein the impact-resistant layer includes an elastic material, and satisfies the following equation: 1.5×h3<h4<10×h3 where h3 indicates a minimum drop height of a steel ball having a weigh of 5-9 g that can result in a crack in a filter including no impact-resistant layer and h4 indicates a minimum drop height of the steel ball that can result in a crack in a filter including the impact-resistant layer.

9. The flat panel display device of claim 8, wherein the impact-resistant layer satisfies the following equation: 1.5×h3<h4<2.0×h3.

10. The flat panel display device of claim 8, wherein the filter is a glass-type filter that includes the plurality of layers formed on a glass.

11. The flat panel display device of claim 8, wherein the filter comprises an external light shield layer which shields external light incident upon the display panel,
wherein the external light shield layer comprises:
a base unit; and
a plurality of pattern units which are formed in the base unit.

12. The flat panel display device of claim 11, wherein a refractive index of the pattern units is 0.3-0.999 times higher than a refractive index of the base unit.

13. The flat display device of claim 11, wherein a refractive index of the pattern units is higher than a refractive index of the base unit.

14. The flat display device of claim 11, wherein a refractive index of the pattern units is 1.0-1.3 times higher than a refractive index of the base unit.

15. A flat panel display device, comprising:
a display panel; and
an external light shield layer which shields external light incident upon the display panel,
wherein the external light shield layer comprises:
a base unit; and
a plurality of pattern units which are formed in the base unit,
wherein the base unit satisfies the following equation: 1.5×h5<h6<10×h5 where h5 indicates a minimum drop height of a steel ball having a weigh of 5-9 g that can result in a crack in a display panel with no external light shield layer and h6 indicates a minimum drop height of the steel ball that can result in a crack in a display panel with the external light shield layer.

16. The flat panel display device of claim 15, wherein the base unit satisfies the following equation: 2.5×h5<h6<3.5×h5.

17. The flat panel display device of claim 15, wherein the base unit comprises at least one of a transparent resin layer and a transparent adhesive layer.

18. The flat panel display device of claim 15, wherein a refractive index of the pattern units is 0.3-1.3 times higher than a refractive index of the base unit.

19. A flat panel display device, comprising:
a display panel; and
a filter which comprises a stack of a plurality of layers including an external light shield layer shielding external light incident upon the display panel,
wherein the external light shield layer comprises:
a base unit; and
a plurality of pattern units which are formed in the base unit,
wherein the base unit satisfies the following equation: 1.5×h7<h8<10×h7 where h7 indicates a minimum drop height of a steel ball having a weigh of 5-9 g that can result in a crack in a filter including no external light shield layer and h8 indicates a minimum drop height of the steel ball that can result in a crack in a filter including the external light shield layer.

20. The flat panel display device of claim 19, wherein the base unit satisfies the following equation: 1.5×h7<h8<2.0×h7.

21. The flat panel display device of claim 19, wherein a refractive index of the pattern units is 0.3-1.3 times higher than a refractive index of the base unit.

22. A filter which is disposed at a front of a display panel and includes a stack of a plurality of layers, the filter comprising:
an impact-resistant layer which includes an elastic material,
wherein the impact-resistant layer satisfies the following equation: 1.5×h1<h2<10×h1 where h1 indicates a drop height of a steel ball having a weigh of 5-9 g to generate a crack in a display panel with no impact-resistant layer and h2 indicates a minimum drop height of the steel ball that can result in a crack in a display panel with the impact-resistant layer.

23. A filter which is disposed at a front of a display panel and includes a stack of a plurality of layers, the filter comprising:
an impact-resistant layer which includes an elastic material,
wherein the impact-resistant layer satisfies the following equation: 1.5×h3<h4<10×h3 where h3 indicates a minimum drop height of a steel ball having a weigh of 5-9 g that can result in a crack in a filter including no impact-resistant layer and h4 indicates a minimum drop height of the steel ball that can result in a crack in a filter including the impact-resistant layer.

24. A filter which is disposed at a front of a display panel and includes a stack of a plurality of layers, the filter comprising:
an external light shield layer which shields external light incident upon the display panel,
wherein the external light shield layer comprises:
a base unit; and
a plurality of pattern units which are formed in the base unit,
wherein the base unit satisfies the following equation: 1.5×h5<h6<10×h5 where h5 indicates a minimum drop height of a steel ball having a weigh of 5-9 g that can result in a crack in a display panel with no external light shield layer and h6 indicates a minimum drop height of the steel ball that can result in a crack in a display panel with the external light shield layer.

25. A filter which is disposed at a front of a display panel and includes a stack of a plurality of layers, the filter comprising:
an external light shield layer which shields external light incident upon the display panel,
wherein the external light shield layer comprises:
a base unit; and
a plurality of pattern units which are formed in the base unit,
wherein the base unit satisfies the following equation: 1.5×h7<h8<10×h7 where h7 indicates a minimum drop height of a steel ball having a weigh of 5-9 g that can result in a crack in a filter including no external light shield layer and h8 indicates a minimum drop height of the steel ball that can result in a crack in a filter including the external light shield layer.
